(19) United States
(12) Patent Application Publication
(10) Pub. No.: US 2021/0097589 A1
(43) Pub. Date: Apr. 1, 2021

(54) System and Method for Authenticating Network Transaction

(71) Applicant: TONGJI UNIVERSITY, Shanghai (CN)

(72) Inventors: Changjun JIANG, Shanghai (CN); Hongzhong CHEN, Shanghai (CN); Chungang YAN, Shanghai (CN); Zhijun DING, Shanghai (CN); Wangyang YU, Shanghai (CN); Yonglong GE, Shanghai (CN)

(73) Assignee: TONGJI UNIVERSITY, Shanghai (CN)

(21) Appl. No.: 16/412,390

(22) Filed: May 14, 2019

Related U.S. Application Data
(63) Continuation-in-part of application No. 15/504,811, filed on Feb. 17, 2017, now abandoned.

(30) Foreign Application Priority Data
Sep. 25, 2014 (CN) 201410499859.1

(51) Int. Cl. G06Q 30/06; H04L 29/06; G06Q 30/02; G06Q 20/38; G06Q 30/00; H04L 29/08

(52) U.S. Cl. CPC G06Q 30/0609; H04L 63/0823; G06Q 30/0641; H04L 67/22; G06Q 20/3821; G06Q 30/0185; G06Q 30/0201

(57) ABSTRACT

Disclosed is a method for authenticating network transaction. The method comprises receiving, by an authentication center, a real-time user behavior during an electronic transaction; receiving, by the authentication center, a software behavior during the electronic transaction; performing, by the authentication center, a user verification of the real-time user behavior by comparing with a user behavior certificate maintained by the authentication center; performing, by the authentication center, a software verification of the software behavior by comparing with a software behavior certificate maintained by the authentication center; in response to a determination that the user verification fails or the software verification fails, terminating, by the authentication center, the electronic transaction.

### CROSS REFERENCE

The present application is a continuation application of U.S. Ser. No. 15/504,811 filed Feb. 17, 2017, which is a 371 of international application of PCT/CN2014/095897 filed Dec. 31, 2014 claiming a priority of CN 201410499859.1 filed Sep. 25, 2014. Both of which are incorporated herein by reference.

### TECHNICAL FIELD

The present disclosure relates to the technical field of authenticating network transaction.

### BACKGROUND

With the quick development of Internet and the continuous progress of computer science and technology, network transaction based on Internet is vigorously and rapidly developed, and this not only provides continuous power for the development of Chinese economy, but also brings great convenience to the living of vast people. More and more people carry out business activities through network transactions and payment modes, and the development prospect of network transaction is very wide.

However, since network transaction and payment platforms have emerged for a short time, the security system of network payment is not prefect, the problem of the trustworthiness of network transaction processes and behaviors becomes increasingly outstanding, and it has already gradually been a bottleneck problem confronted by the development of the network transaction. The problem of trustworthiness in the network transaction mainly comprises two aspects, wherein one is the user identity trustworthiness problem, i.e., whether the identity of the user participating in the network transaction is legal or not; and the other is the software trustworthiness problem, i.e., whether behaviors of software of all transaction parties in the network transaction and behaviors of interaction between software are expectable or not. Aiming at the two classes of problems, at present, E-commerce enterprises generally adopt the solutions of digital certificates and patch update or version upgrade of software. As investigated and surveyed, by taking a large network payment platform company in China as an example, the current solution strategies have obvious defects in industrial application, wherein one is that, after account passwords of a user are stolen, transactions performed by hackers through a stolen user account cannot be recognized and the problem of user identity trustworthiness which jeopardizes user benefits occurs; and the other is that unexpected behaviors met during system operation cannot be found and processed in time.

### SUMMARY

A method for authenticating network transaction, comprising: receiving, by an authentication center, a real-time user behavior during an electronic transaction among a client, an e-commerce platform, and a payment platform interconnected via a network, wherein the real-time user behavior is collected based on a user performing the electronic transaction from the client to access the e-commerce platform and the payment platform; receiving, by the authentication center, a software behavior during the electronic transaction, wherein the software behavior is collected based on software installed on the client, the e-commerce platform and the payment platform; performing, by the authentication center, a user verification of the real-time user behavior by comparing with a user behavior certificate maintained by the authentication center; performing, by the authentication center, a software behavior verification of the software behavior by comparing with a software behavior certificate maintained by the authentication center; in response to a determination that the user verification fails or the software behavior verification fails, terminating, by the authentication center, the electronic transaction.

A system for authenticating network transaction, comprising: a client used by a user during an electronic transaction, wherein the client is configured to collect real-time user behavior and client software behavior based on the user performing the electronic transaction; an e-commerce platform coupled with the client, wherein the e-commerce platform is configured to collect e-commerce software behavior during the electronic transaction; a payment platform coupled with the e-commerce platform, wherein the payment platform is configured to collect payment software behavior during the electronic transaction; an authentication center coupled with the e-commerce platform and the payment platform, wherein the authentication center is configured to perform a user verification of the real-time user behavior received from the client by comparing with a user behavior certificate maintained by the authentication center, perform a software verification of the e-commerce software behavior and the payment software behavior by comparing with a software behavior certificate maintained by the authentication center, and in response to a determination that the user verification fails or the software verification fails, terminate the electronic transaction.

A non-transitory computer-readable storage medium, containing a set of instructions which, when executed by a processor, cause the processor to perform a method for authenticating network transaction, comprising: receiving, by an authentication center, a real-time user behavior during an electronic transaction among a client, an e-commerce platform, and a payment platform interconnected via a network, wherein the real-time user behavior is collected based on a user performing the electronic transaction from the client to access the e-commerce platform and the payment platform; receiving, by the authentication center, a software behavior during the electronic transaction, wherein the software behavior is collected based on software installed on the client, the e-commerce platform and the payment platform; performing, by the authentication center, a user verification of the real-time user behavior by comparing with a user behavior certificate maintained by the authentication center; performing, by the authentication center, a software behavior verification of the software behavior by comparing with a software behavior certificate maintained by the authentication center; in response to a determination that the user verification fails or the software behavior verification fails, terminating, by the authentication center, the electronic transaction.

### BRIEF DESCRIPTION OF THE DRAWINGS

FIG. 1 is an architecture diagram of a network transaction trustworthiness authentication system.

FIG. 1A is an enlarged part of the FIG. 1.

FIG. 1B is an enlarged part of the FIG. 1.

FIG. 1C is an enlarged part of the FIG. 1.

FIG. 1D is an enlarged part of the FIG. 1.

FIG. 2 is a module deployment diagram of a network transaction trustworthiness authentication system.

FIG. 2A is an enlarged part of the FIG. 2.

FIG. 2B is an enlarged part of the FIG. 2.

FIG. 3 is an authentication flowchart of a network transaction trustworthiness authentication system.

FIG. 3A is an enlarged part of the FIG. 3.

FIG. 3B is an enlarged part of the FIG. 3.

FIG. 4 is a flowchart of a method for authenticating network transaction according to the present application.

FIG. 5 is an architecture diagram for authenticating network transaction according to the present application.

FIG. 6 is a block diagram of system for authenticating network transaction according to the present application.

### DETAILED DESCRIPTION OF THE PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated herein.

The application discloses a method for authenticating network transaction, comprising: Step 1, receiving, by an authentication center, a real-time user behavior during an electronic transaction among a client, an e-commerce platform, and a payment platform interconnected via a network, wherein the real-time user behavior is collected based on a user performing the electronic transaction through the e-commerce platform and the payment platform; Step 2, receiving, by the authentication center, a software behavior during the electronic transaction, wherein the software behavior is collected based on software on the client, the e-commerce platform and the payment platform; Step 3, performing, by the authentication center, a user verification of the real-time user behavior by comparing with a user behavior certificate maintained by the authentication center; Step 4, performing, by the authentication center, a software behavior verification of the software behavior by comparing with a software behavior certificate maintained by the authentication center; Step 5, in response to a determination that the user verification fails or the software behavior verification fails, terminating, by the authentication center, the electronic transaction.

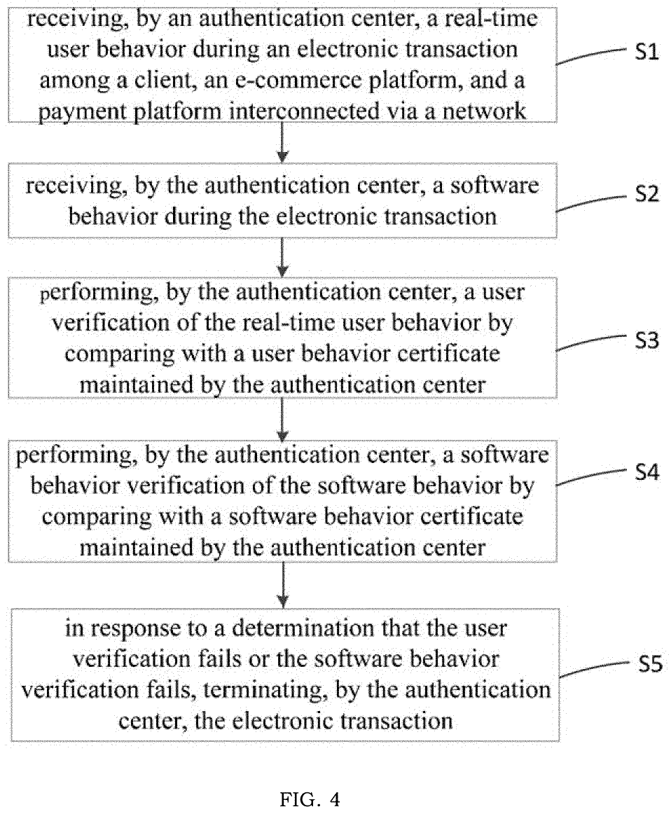

FIG. 4 illustrates a flowchart of a method for authenticating network transaction according to the present application.

The network transaction (e.g., electronic transaction, transaction process, or e-commerce transaction) is performed among three components/parties, a user client, an E-Commerce or E-Merchant website/platform, and a third-party payment website/platform.

An authentication center is a fourth component/party. The authentication center can detect the abnormal behavior in the electronic transaction by monitoring and authenticating the tripartite transaction subjects through the software behavior and user behavior authentication technology.

A software behavior monitor is a data packet monitor installed on the E-Commerce website, the third-party payment platform and the user client, which is used to monitor, in real time, data packets transmitted between the three parties in a complete transaction, extract and integrate necessary parameter information (comprising a URL address and a parameter and the like) in the data packets, so as to send key information to the real-time software behavior verification system. The three-party software behavior monitor is technically based on jpcap, and mainly captures HTTP data packets, and extracts URL addresses and parameter information in the data packets, a serial number of the E-Commerce and a serial number of the third-party payment platform in the three parties of the transaction, and then establishes a socket connection with the real-time software behavior verification system, and sends the key information to the real-time software behavior verification system by using a TCP data packet.

After receiving data packets of interaction information in the transaction that are respectively submitted by the software behavior monitors, the real-time software behavior verification system extracts and integrates key sequences and information in the data packets, and compares a user behavior interaction sequence with the software behavior model in real time according to a global unique order number, and sends an alarm and terminates the transaction in the case of illegal behaviors comprising disorder and identity spoofing.

In particular, when a user performs an electronic transaction, the user logs into a certificated client, and uploads a user digital certificate. An E-merchant and a third-party payment platform also upload digital certificates thereof.

Step 1, after verifying the digital certificates, an authentication center, receives a real-time user behavior during an electronic transaction among a client, an e-commerce platform, and a payment platform interconnected via a network, wherein the real-time user behavior is collected based on a user performing the electronic transaction through the e-commerce platform and the payment platform.

User behavior authentication system detects a real-time user behavior during electronic transaction, and compares the detected user behavior during transaction with a user behavior certificate. If the similarity between the real time user behavior and the user behavior certificate is higher than a preset threshold, the user can continue the electronic transaction.

Otherwise, if the similarity between the real time user behavior and the user behavior certificate is lower than a preset threshold, the comparing result will be uploaded to the authentication center for further authentication. If the authentication of the authentication center successes, the user can continue the electronic transaction. Otherwise, the electronic transaction will be terminated.

Step 2, a software behavior monitoring system detects software behaviors of the user client, the E-merchant and the third-party payment platform respectively. The software behavior monitoring system may be a data packet monitor or a process respectively installed on the E-Commerce website, the third-party payment platform and the user client, which monitors the behavior of the E-Commerce website, the third-party payment platform and the user client in real time, and send the detected information to the authentication center.

Step 3, an authentication center performs a user verification of the real-time user behavior by comparing with a user behavior certificate maintained by the authentication center.

Step 4, the authentication center performs a software behavior verification of the software behavior by comparing with a software behavior certificate maintained by the authentication center.

Step 5, the authentication center terminates the electronic transaction in response to a determination that the user verification fails or the software behavior verification fails.

In particular, when any one of the software behaviors does not pass the verification, the electronic transaction will be terminated. That is to say, if all of the similarities between the real time behavior and its corresponding behavior certificate are higher than its corresponding preset threshold, the user can continue the electronic transaction. Otherwise, if any one of the similarities between the real time behavior and its corresponding behavior certificate is lower than its corresponding preset threshold, the electronic transaction will be terminated.

When an e-commerce transaction is terminated by the authentication center, the e-commerce transaction is highlighted on a visualization platform (e.g., the secured client on which the user is conducting the electronic transaction or the administrative host of the e-commerce platform or the payment platform) as an abnormal transaction.

In an embodiment of the present application, the method further comprises receiving, by the authentication center, an access log from the client after the electronic transaction is completed; updating, by the authentication center, the user behavior certificate in response to the access log.

The user behavior certificate is updated by the authentication center via mining the access log.

Moreover, the authentication center audits and issues digital certificate to the E-merchant and the payment platform; and mines the software behavior certificate of the E-merchant and the payment platform.

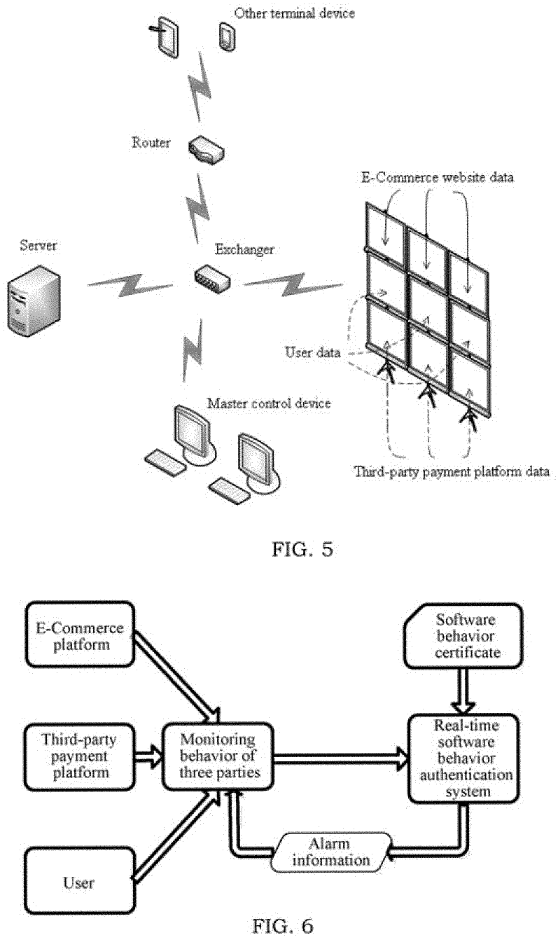

FIG. 5 is an architecture diagram for authenticating network transaction according to the present application. FIG. 6 is a block diagram of system for authenticating network transaction according to the present application.

The application further discloses a system for authenticating network transaction, as shown in FIG. 6, comprising: a client used by a user during an electronic transaction, wherein the client is configured to collect real-time user behavior and client software behavior based on the user performing the electronic transaction; an e-commerce platform coupled with the client, wherein the e-commerce platform is configured to collect e-commerce software behavior during the electronic transaction; a payment platform coupled with the e-commerce platform, wherein the payment platform is configured to collect payment software behavior during the electronic transaction; an authentication center coupled with the e-commerce platform and the payment platform, wherein the authentication center is configured to perform a user verification of the real-time user behavior received from the client by comparing with a user behavior certificate maintained by the authentication center, perform a software verification of the e-commerce software behavior and the payment software behavior by comparing with a software behavior certificate maintained by the authentication center, and in response to a determination that the user verification fails or the software verification fails, terminate the electronic transaction.

The authentication center is a fourth party monitoring center, which has a monitoring data visualization platform. The user data, the E-commerce website data, and the third party payment platform data which indicates behaviors of corresponding client is displayed on the monitoring data visualization platform, as shown in FIG. 5. These data is obtained from the monitored external e-commerce platform through real-time data services. The visualization platform highlights the abnormal transaction, so that business personnel can discover and analyze abnormal transactions.

The authentication center communicates with the E-commerce website, the third party payment platform, and the user client (or other terminal device) through information exchange technology, such as a wire network or a wireless network.

The fourth-party authentication center mainly has functions of monitoring and authenticating a network transaction process, performing digital authentication to three transaction parties, verifying user identity through the user behavior certificate and verifying a network transaction behavior of the three transaction parties through the software behavior certificate. The fourth-party authentication center is divided into three sub-parts i.e., the digital certificate, the user behavior certificate and the software behavior certificate to perform triple authentication to the network transaction process. The user domain is mainly responsible for uploading the user digital certificate, verifying the user identity through the user behavior certificate as well as acquiring and uploading a client software behavior in the transaction process. The E-merchant domain and the third-party payment domain mainly have functions of uploading digital certificates thereof, as well as acquiring and uploading software behaviors.

The user domain, the E-merchant domain and the third-party payment domain each has a software behavior monitor, the software behavior monitor monitors data packets transmitted in a transaction, and sending data packets to the software behavior verification system. The type of the monitor is not limited herein.

The entire system is deployed to the apache server, which is available on each operating system. The monitoring system emphasizes the real-time of the data, and the purpose is providing real-time data call service. When the data come from a third party system instead of a local database, this part of the service will have the ability to access both external and internal data sources.

In some embodiments, examples of monitored behaviors may include electronic/online user actions/activities such as data inputting (e.g., inputting user names and passwords), web-page accessing (e.g., accessing specific secured web sites), web-browsing patterns, payment transactions, data updating actions (e.g., updating personal credentials), etc. The software behavior monitoring system may collect these monitored user behaviors, and by sent the monitored behavior to the authentication center, so as to be compared with the software behavior certificate.

The present application further provides a non-transitory computer-readable storage medium, containing a set of instructions which, when executed by a processor, cause the processor to perform a method for authenticating network transaction, comprising: receiving, by an authentication center, a real-time user behavior during an electronic transaction among a client, an e-commerce platform, and a payment platform interconnected via a network, wherein the real-time user behavior is collected based on a user performing the electronic transaction through the e-commerce platform and the payment platform; receiving, by the authentication center, a software behavior during the electronic transaction, wherein the software behavior is collected based on software on the client, the e-commerce platform and the payment platform; performing, by the authentication center, a user verification of the real-time user behavior by comparing with a user behavior certificate maintained by the authentication center; performing, by the authentication center, a software verification of the software behavior by comparing with a software behavior certificate maintained by the authentication center; in response to a determination that the user verification fails or the software verification fails, terminating, by the authentication center, the electronic transaction.

The method further comprises: receiving, by the authentication center, an access log from the client after the electronic transaction is completed; updating, by the authentication center, the user behavior certificate in response to the access log.

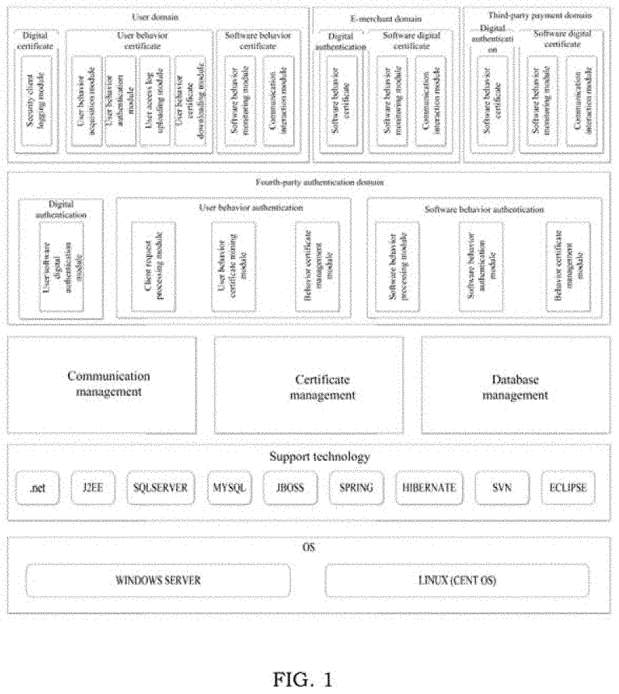

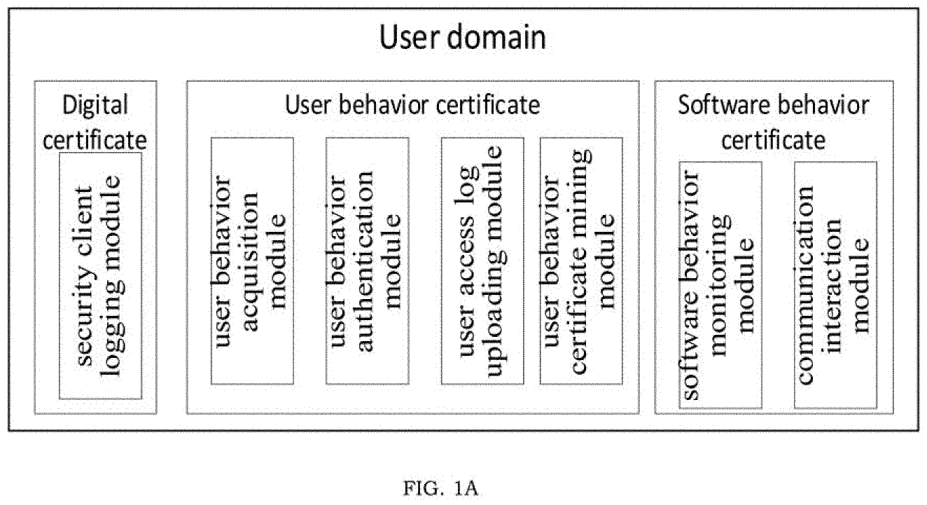

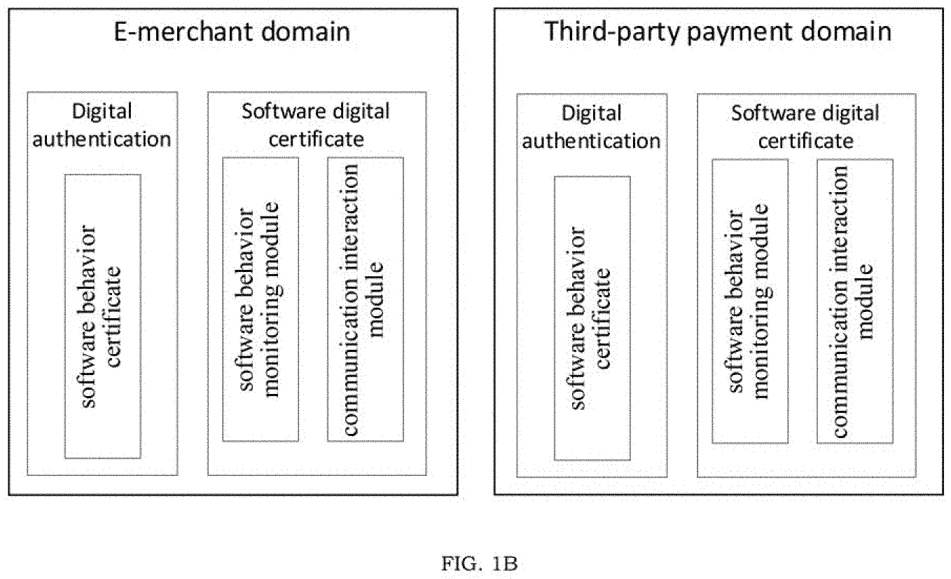

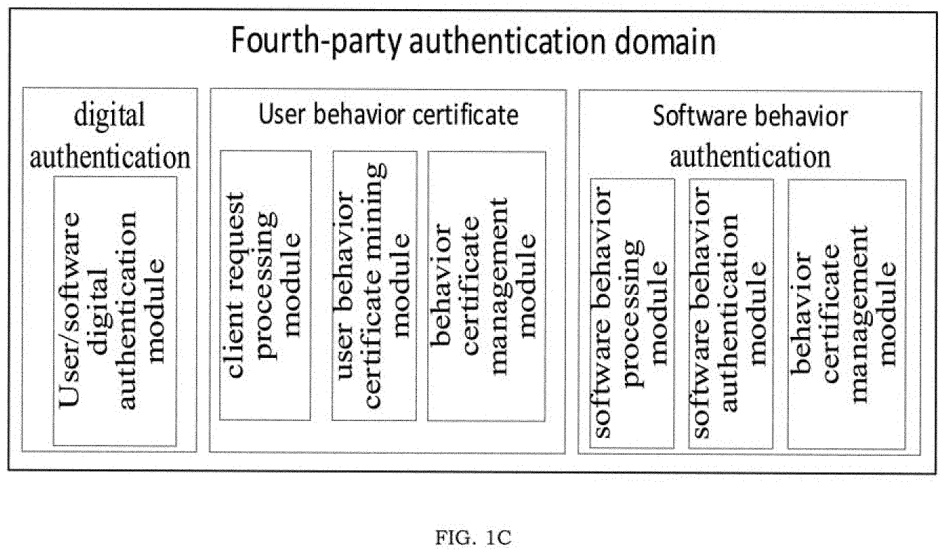

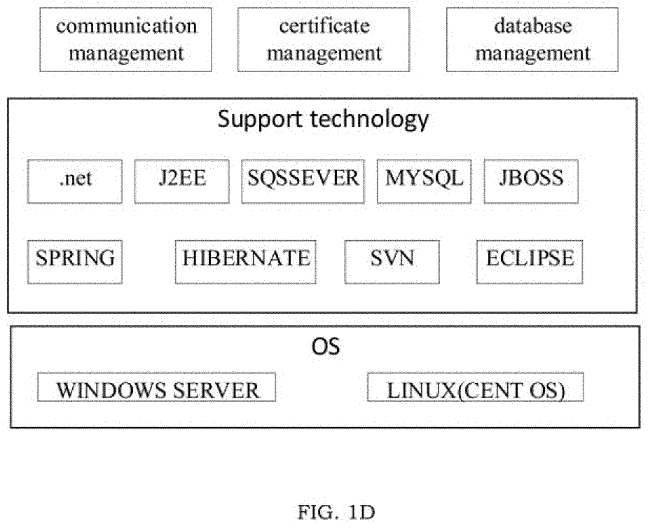

FIG. 1 illustrates an architecture diagram of a network transaction trustworthiness authentication system.

As illustrated in FIG. 1, a bottom layer of the network transaction trustworthiness authentication system supports multiple mainstream operating systems, i.e., Windows and Linux, meaning the system, which not only can be deployed on a Window system, but also can be deployed on a Linux system, has very good cross-platform capability. The bottom layer may support technologies including .net, J2EE, SqlServer, MySql, JBoss, SPRING, HIBERNATE, etc., and may provide a good support for application development on a layer above (the second layer). The second layer may include three basic management modules, i.e., respectively a communication management module, a certificate management module and a database management module.

The communication management module is mainly responsible for packaging network communication functions according to a specific demand of the system, providing communication services such as data exchange for the upper layers, and providing the communication services to a fourth party in a network transaction for calling to perform data exchange. The certificate management module is responsible for performing uniform management to a software behavior certificate, a user behavior certificate and a digital certificate, including operations such as searching, updating and issuance of certificates. The database management module is mainly responsible for updating and maintaining a database and improving data access efficiency.

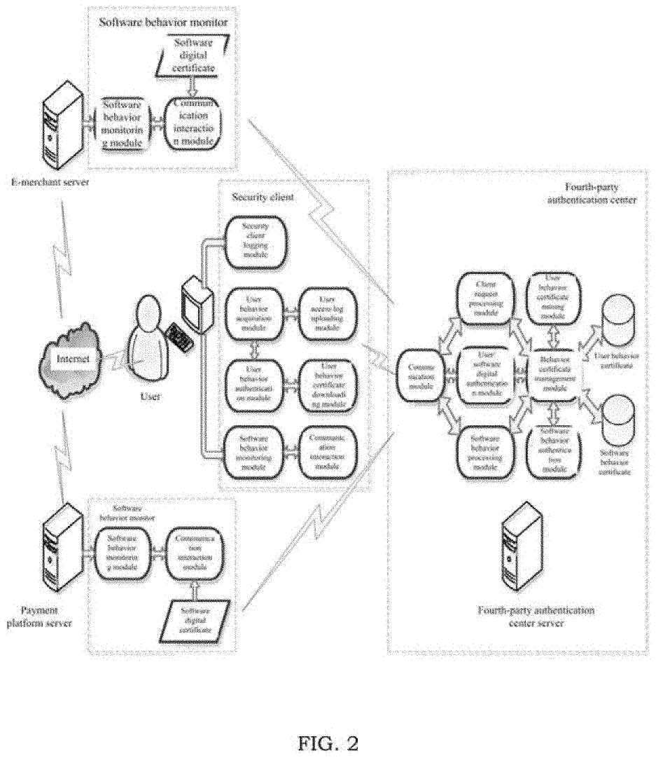

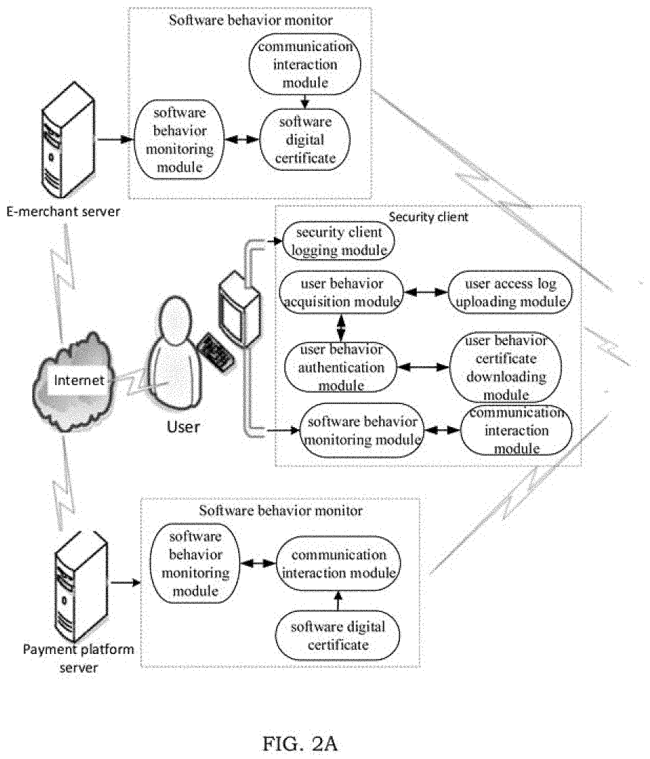

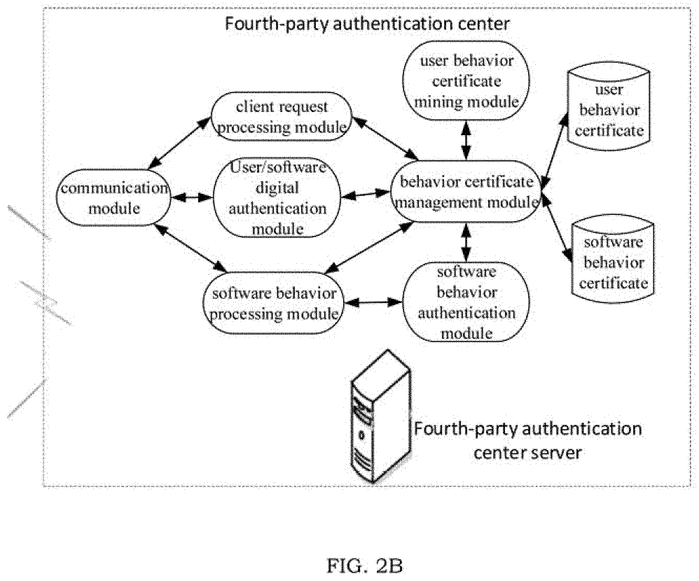

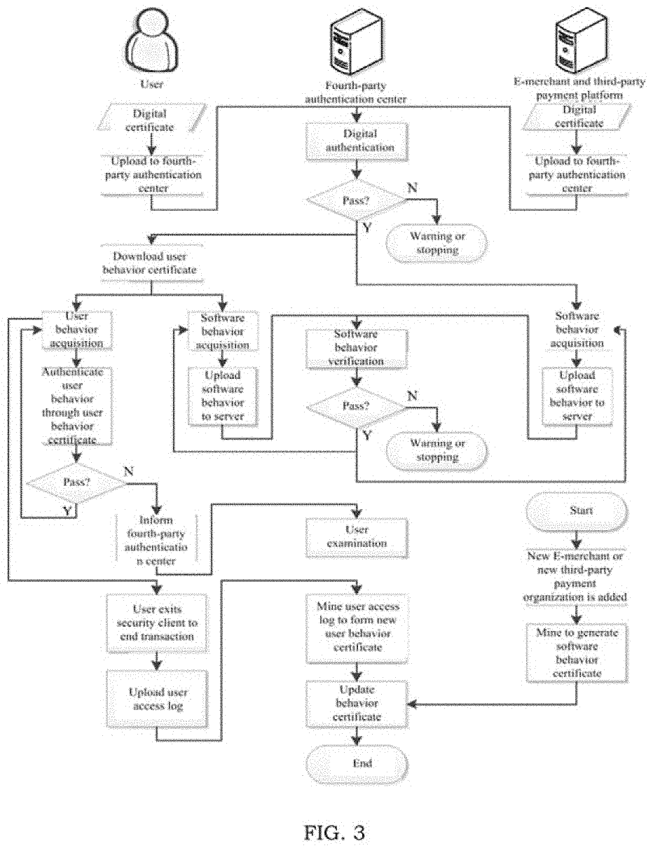

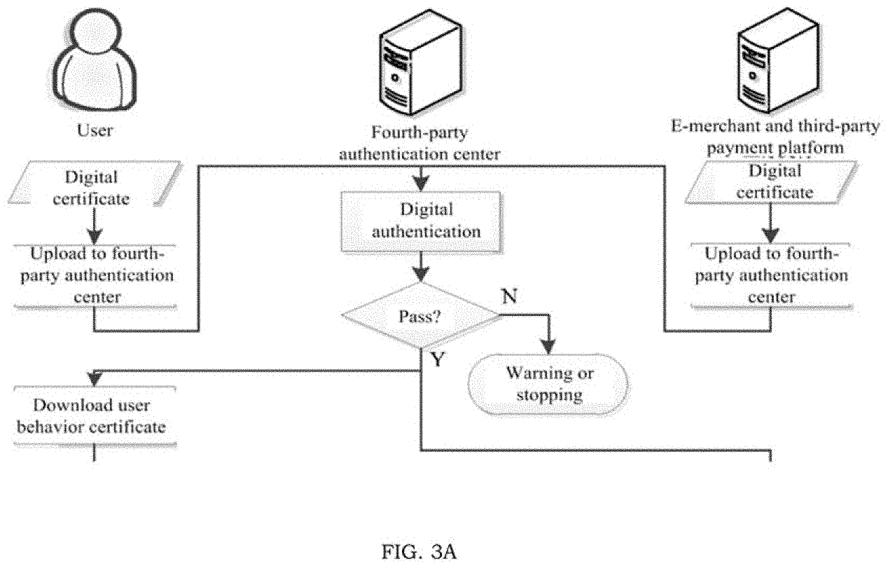

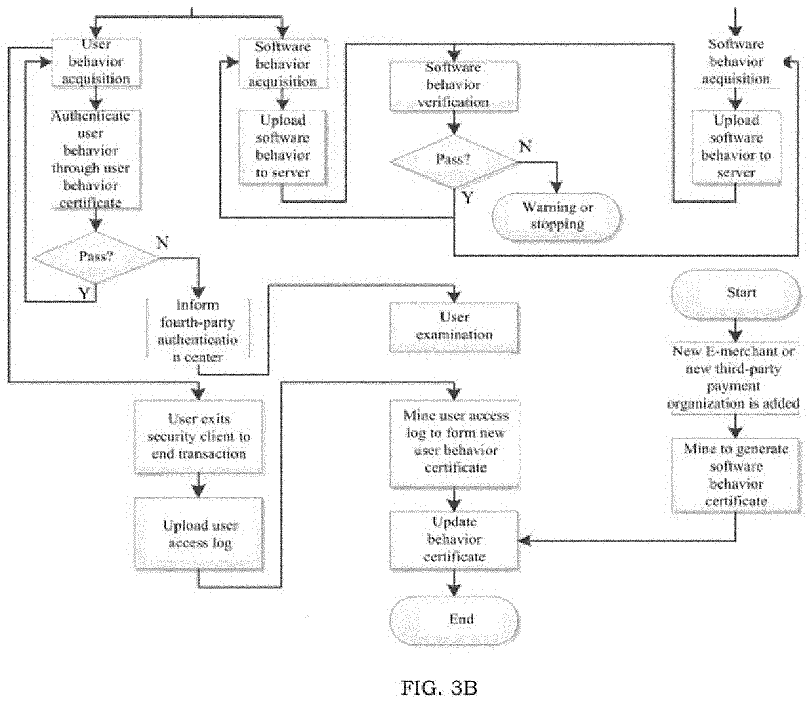

A fourth-party authentication domain/system (e.g., the fourth-party authentication center of FIG. 2 and FIG. 3) of the network transaction trustworthiness authentication system may be positioned above the basic management modules, and may have functions of monitoring and authenticating a network transaction process, performing digital authentication to three transaction parties, verifying trustworthiness of user identity through the user behavior certificate and verifying trustworthiness of a network transaction behavior of the three transaction parties through the software behavior certificate. The fourth-party authentication domain may include three modules to manage the digital certificate, the user behavior certificate and the software behavior certificate, and to perform three-way authentication to the network transaction process. Another three systems/domains, i.e., a user domain, an E-commerce domain and a third-party payment domain, may form the top layer of the network transaction trustworthiness authentication system, and may be positioned above the fourth-party authentication domain.

The user domain (e.g., client of FIG. 2 and FIG. 3), which may be installed in a client computer, is mainly responsible for uploading the user digital certificate, verifying the user identity through the user behavior certificate, as well as acquiring and uploading a client software behavior in the transaction process. The E-merchant domain (e.g., E-merchant server of FIGS. 2 and 3) and the third-party payment domain (e.g., payment platform server of FIGS. 2 and 3), which may be two separate web-sites accessible via network, mainly have functions of uploading digital certificates thereof, as well as acquiring and uploading software behaviors. Deployment situations of all function modules of the network transaction trustworthiness authentication system and an authentication protocol process of entire system operation are given below, as illustrated in FIG. 2 and FIG. 3.

As illustrated in FIG. 2-and FIG. 3, the authentication protocol process of the entire network transaction trustworthiness authentication system comprises the following steps: when an electronic transaction (e.g., a e-commerce transaction) occurs, a user may upload a digital certificate to a secured client computer, and may perform digital authentication by logging into the secured client. An E-commerce platform (e.g., an Amazon-like e-merchant web site) and a third-party payment platform (e.g., a paypal-like web site) may also simultaneously upload their respective digital certificates to the secured client to perform corresponding digital authentication. After the digital authentication on the secured client passes, the secured client may download from the authentication center a behavior certificate through a user behavior certificate downloading module, and the three parties (the secured client, the e-commerce platform, and the third-party payment platform) may formally enter a transaction process (or “electronic transaction”).

In the transaction process, the secured client acquires a user behavior in real time through its own user behavior acquisition module, provides the user behavior to its user behavior authentication module, and authenticates trustworthiness of the user's access behavior according to the user behavior certificate downloaded from the fourth-party authentication center. If authentication passes, the secured client continuously acquires additional user behavior and perform authentication as shown above. If the authentication fails, the secured client uploads a detailed authentication result to the authentication center, and the authentication center performs examination and judgment of the user behavior. User behavior may include a pattern of actions performed by a specific user on the three parties during an electronic transaction. For example, the user may have a specific pattern of accessing a specific e-commerce web site, browsing merchandises, selecting items for purchasing, placing orders, and making payments via a payment web site. This specific pattern of actions may contain characteristics that are either unique (or with higher-than-threshold probability) or consistent to the specific user. As a result, the specific pattern may be used to authenticate the specific user and the electronic transaction.

Simultaneous to the acquiring of user behavior, the secured client acquires a client software behavior during the electronic transaction in real time through its software behavior acquisition module, and uploads the client software behavior to the authentication center by its communication interaction module. Likewise, the E-merchant platform and the third-party payment platform may acquire corresponding software behaviors in real time through their respective software behavior monitoring modules, and use interaction modules to upload these software behaviors to the authentication center. Software behavior may refer to a pattern of software operations that are associated with a specific user or specific transaction during an electronic transaction. For example, when a user places an order with the e-commerce platform and make a payment with the payment platform, the software on the e-commerce platform and/or the payment platform may respectively perform a set of e-commerce software operations and payment software operations (including user-interface operations, network operations, database operations, server operations, cloud operations, storage operations, memory operations, etc.) to complete the placing of the order and the making of payment. The e-commerce software behavior and the payment software behavior may contain characteristics that are either unique (or with higher-than-threshold probability) or consistent to the specific user, and may be used to authenticate the user and the electronic transaction.

The authentication center may verify the user and the electronic transaction by evaluating the user behavior and the software behavior from the three parties. Specifically, the authentication center may perform a user verification by comparing the user behavior received from the secured client with a user behavior certificate maintained by the authentication center. The user behavior certificate may contain past record of user actions performed by the specific user (or a type of user similar to the specific user) during similar electronic transactions, or contain analysis/pattern of the typical user actions during similar electronic transactions. By comparing the user behavior and the user behavior certificate, the authentication center may identify unfamiliar pattern of user actions indicating user identity misuse, identify repetitive user actions (e.g., placing similar order repetitively) indicating hacking situations, or identify suspicious user actions (e.g., a direct purchase order without browsing or reviewing goods). If the authentication center determines that there is a higher-than-threshold possibility that the real-time user behavior is not consistent with the user behavior certificate, the authentication center may deem the user verification failed.

The authentication center may verify the user and the electronic transaction by evaluating the software behavior from the three parties. Specifically, the authentication center may perform one or more software verifications by comparing the software behavior received from the secured client, the e-commerce platform and the payment platform with respective client software behavior certificate, e-commerce software certificate, and payment software certificate maintained by the authentication center. The software behavior certificate may contain past record of software operations associated with the specific user (or a type of user similar to the specific user) during similar electronic transactions, or contain analysis/pattern of the typical software operations during similar electronic transactions. By comparing the software behavior and the software behavior certificate, the authentication center may identify unfamiliar pattern of software operations indicating a threat to the electronic transaction, or identify suspicious operations (e.g., payment from an oversea bank account). If the authentication center determines that there is a higher-than-threshold possibility that any one of the real-time software behaviors is not consistent with its corresponding software behavior certificate, the authentication center may deem software verifications failed.

If user verification and software behavior verification pass, the authentication center sends feedback information to the three parties, and the transaction process can continuously performed. In this case, the real-time acquisition and monitoring of the software behaviors of the three parties may continuously performed during the current and subsequent electronic transactions. If the above authentication fails, the authentication center gives a broadcast notice about an abnormality occurring in the transaction process to the three parties of the transaction, and the electronic transaction may be terminated either by the authentication center, or by any one of the three parties.

After the electronic transaction is completed, the secured client uploads a new access log to the authentication center through a user access log uploading module. The new access log may record the user behavior, the software behavior from the secured client, as well as all certificates associated with the user and the electronic transaction. The authentication center sends feedback information after receiving the new access log, and the user exits the secured client.

Then, the authentication center calls a user behavior certificate mining module through a certificate management module to mine the new user access log, and updates the user behavior certificate and software behavior certificates maintained by itself and associated with the user and the electronic transaction. When a new E-merchant platform or a new third-party payment platform is added into the whole system, the authentication center may firstly audit the new platforms, and a corresponding digital certificate is issued after the auditing passes. Further, the authentication center may generate corresponding software behavior certificates for the platforms by analyzing the website source codes of these platforms. Afterward, the generated/mined software behavior certificates may be uploaded to the authentication center and is uniformly managed by its behavior certificate management module.

Systems and methods for authenticating network transaction have been disclosed. The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments of the disclosure may be useful machine operations. In addition, one or more embodiments of the disclosure also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present disclosure may be implemented as one or more computer programs or as one or more computer program modules embodied in one or more computer readable media. The term non-transitory computer readable storage medium refers to any data storage device that can store data which can thereafter be input to a computer system. Computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs) CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present disclosure have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

In addition, while described virtualization methods have generally assumed that virtual machines present interfaces consistent with a particular hardware system, persons of ordinary skill in the art will recognize that the methods described may be used in conjunction with virtualizations that do not correspond directly to any particular hardware system. Virtualization systems in accordance with the various embodiments, implemented as hosted embodiments, non-hosted embodiments, or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless of the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

What is claimed is:

1. A method for authenticating network transaction, comprising:
receiving, by an authentication center, a real-time user behavior during an electronic transaction among a client, an e-commerce platform, and a payment platform interconnected via a network, wherein the real-time user behavior is collected based on a user performing the electronic transaction from the client to access the e-commerce platform and the payment platform;
receiving, by the authentication center, a software behavior during the electronic transaction, wherein the software behavior is collected based on software installed on the client, the E-commerce platform and the payment platform;
performing, by the authentication center, a user verification of the real-time user behavior by comparing with a user behavior certificate maintained by the authentication center;
performing, by the authentication center, a software behavior verification of the software behavior by comparing with a software behavior certificate maintained by the authentication center; and
in response to a determination that the user verification fails or the software behavior verification fails, terminating, by the authentication center, the electronic transaction.

2. The method according to claim 1, further comprising
receiving, by the authentication center, an access log from the client after the electronic transaction is completed; and
updating, by the authentication center, the user behavior certificate in response to the access log.

3. The method according to claim 2, wherein the user behavior certificate is updated by the authentication center via mining the access log.

4. The method according to claim 1, further comprising
auditing and issuing, by the authentication center, digital certificate to the E-merchant platform and the payment platform; and
mining the software behavior certificate from the E-merchant platform and the payment platform.

5. The method according to claim 1, wherein when the electronic transaction is terminated by the authentication center, the e-commerce transaction is highlighted on the visualization platform as an abnormal transaction.

6. A system for authenticating network transaction, comprising:
a client used by a user during an electronic transaction, wherein the client is configured to collect real-time user behavior and client software behavior based on the user performing the electronic transaction;
an e-commerce platform coupled with the client, wherein the e-commerce platform is configured to collect e-commerce software behavior during the electronic transaction;
a payment platform coupled with the e-commerce platform, wherein the payment platform is configured to collect payment software behavior during the electronic transaction;
an authentication center coupled with the e-commerce platform and the payment platform, wherein the authentication center is configured to
perform a user verification of the real-time user behavior received from the client by comparing with a user behavior certificate maintained by the authentication center,
perform a software verification of the client software behavior, the e-commerce software behavior, and the payment software behavior by comparing with a software behavior certificate maintained by the authentication center, and
in response to a determination that the user verification fails or the software verification fails, terminate the electronic transaction.

7. The system according to claim 6, wherein
the authentication center updates the user behavior certificate after the electronic transaction in response to an access log of the user generated by the client.

8. The method according to claim 7, wherein the authentication center updates the user behavior certificate via mining the access log.

9. The method according to claim 6, wherein the authentication center is further configured to
audit and issue digital certificate to the E-merchant and the payment platform; and
mine the software behavior certificate of the E-merchant platform and the payment platform.

10. The method according to claim 6, wherein
when the electronic transaction is terminated by the authentication center, the electronic transaction is highlighted on the client as an abnormal transaction.

11. A non-transitory computer-readable storage medium, containing a set of instructions which, when executed by a processor, causes the processor to perform a method for authenticating network transaction, comprising:
receiving, by an authentication center, a real-time user behavior during an electronic transaction among a client, an e-commerce platform, and a payment platform interconnected via a network, wherein the real-time user behavior is collected based on a user performing the electronic transaction from the client to access the e-commerce platform and the payment platform;
receiving, by the authentication center, a software behavior during the electronic transaction, wherein the software behavior is collected based on software installed on the client, the e-commerce platform and the payment platform;
performing, by the authentication center, a user verification of the real-time user behavior by comparing with a user behavior certificate maintained by the authentication center;
performing, by the authentication center, a software verification of the software behavior by comparing with a software behavior certificate maintained by the authentication center; and
in response to a determination that the user verification fails or the software verification fails, terminating, by the authentication center, the electronic transaction.

12. The non-transitory computer-readable storage medium according to claim 11, wherein the method further comprises:
receiving, by the authentication center, an access log from the client after the electronic transaction is completed; and
updating, by the authentication center, the user behavior certificate in response to the access log.

13. The non-transitory computer-readable storage medium according to claim 11, further comprising
auditing and issuing, by the authentication center, digital certificate to the E-merchant platform and the payment platform; and
mining the software behavior certificate from the E-merchant platform and the payment platform.
